(19) United States
(12) Patent Application Publication
(10) Pub. No.: US 2024/0384995 A1
(43) Pub. Date: Nov. 21, 2024

(54) SYSTEMS AND METHODS FOR SEGMENT BASED APPROACH TO OPTIMIZING ROUTING THROUGH RANDOMIZED PICKING LOCATIONS

(71) Applicant: Coupang Corp., Seoul (KR)

(72) Inventors: Venkataraja NELLORE, Seoul (KR); Harshal Dilip WANJARI, Issaquah, WA (US); Ankit BHATNAGAR, Seoul (KR); Xinhui ZHANG, Centerville, OH (US); Ying QIN, Shanghai (CN); Daniel CARDONA, Seoul (KR); Ashish CHATTERJEE, Seoul (KR)

(21) Appl. No.: 18/318,115

(22) Filed: May 16, 2023

(51) Int. Cl. G01C 21/20; G01C 21/00

(52) U.S. Cl. CPC G01C 21/206; G01C 21/005; G01C 21/383; G01C 21/3841

(57) ABSTRACT

Computerized systems and methods for segment based approach to routing picking are disclosed. The systems and methods may include performing steps for: receiving a floorplan of a first set of location IDs, wherein the first set of location IDs correspond to locations of multiple inventory items arranged in a floor; generating one or more base segments that connect the first set of location IDs; generating one or more route segments by combining the one or more base segments with one or more demand points corresponding to a second set of location IDs; generating one or more dispatch routes through the one or more route segments based on an optimal routing of resources that maximizes a density metric of the multiple inventory items included in the one or more dispatch routes; and assigning a first user to a combination of the one or more dispatch routes.

### TECHNICAL FIELD

The present disclosure generally relates to computerized systems and methods for segment based approach to routing. In particular, embodiments of the present disclosure relate to inventive and unconventional systems that use an improved vehicle routing model with the goal of maximizing density using a segment based approach.

### BACKGROUND

A vehicle routing problem (VRP), also known as traveling salesman problem, is a mathematical optimization problem that involves determining the most efficient way to route a fleet of vehicles from a central depot to a set of delivery or service locations. The typical objective of the problem is to minimize the total distance traveled by the vehicles, the number of vehicles used, or the total time taken to complete all deliveries, subject to a set of constraints such as vehicle capacity or time windows.

One of the areas that can benefit from solving VRP is order picking in warehouses. In this context, a VRP involves determining the most efficient way to route a fleet of vehicles, such as forklifts, carts, or pickers, to pick up items from storage locations, while reducing travel time and improving the utilization of resources.

Order picking has long been identified as one of the most labor-intensive and costly activity for almost every warehouse. The cost of order picking is estimated to be as much as 55% of the total warehouse operating expense. Any underperformance in order picking can lead to unsatisfactory service and high operational cost for its warehouse, and consequently for the whole supply chain. In order to operate efficiently, the order picking process needs to be robustly designed and optimally controlled, which can lead to significant improvements in order accuracy, throughput, and efficiency.

Traditional VRP models, however, fail to meet the growing complexity and scale of large warehouses. Large warehouses can cover hundreds of thousands of square feet with thousands of products and hundreds of pickers-workers that pick products from inventory to fulfil an order. Special handling is frequently required for fragile, hazardous, or temperature-sensitive items. Traditional VRP models are also unfit to handle the dynamic nature of order fulfilment, where orders may come in at any time with any number of combinations of available products. New products are constantly added, existing products are moved around, old products are removed, and even the physical space may be rearranged with new barriers or obstacles that interfere with movement of pickers. In this way, using traditional VRP models to optimize order picking processes is unable to adequately address needs of large warehouses, where workers, products, and resources constantly change.

Previous attempts to solve this complex VRP have involved over-digitalization of processes and resources that play a part in order picking processes. More frequently than not, however, these attempts have led to a mountain of data that pile on without being given a meaningful analysis or non-user friendly implementations that become obsolete through non-use or incompliance.

Therefore, there is a need for improved systems and methods for facilitating the order picking process using new and improved VRP models. These improved systems and methods should be able to solve the complex optimization problem facing large warehouses by gathering data at strategically implemented time points and processing them in the background to allocate and assign various resources to the most efficient place and time under the circumstances, with minimal input from human operators. The improved systems and methods should also be configured to utilize ubiquity of mobile devices in modern day warehouses, taking advantage of their mobility and connectivity to enable new functions that were never possible before.

### SUMMARY

One aspect of the present disclosure is directed to a system for segment based approach to routing picking. The system may comprise a memory storing instructions; and at least one processor configured to execute the instructions to perform operations. The operations may comprise: receiving a floorplan of a first set of location IDs, wherein the first set of location IDs correspond to locations of multiple inventory items arranged in a floor; generating one or more base segments that connect the first set of location IDs of the multiple inventory items; generating one or more route segments by combining the one or more base segments with one or more demand points corresponding to a second set of location IDs, wherein the second set of location IDs correspond to inventory items included in customer orders; generating one or more dispatch routes through the one or more route segments based on an optimal routing of resources that maximizes a density metric of the multiple inventory items included in the one or more dispatch routes; and assigning a first user to a combination of the one or more dispatch routes.

Another aspect of the present disclosure is directed to a method for segment based approach to routing picking. The method may comprise: receiving a floorplan of a first set of location IDs, wherein the first set of location IDs correspond to locations of multiple inventory items arranged in a floor; generating one or more base segments that connect the first set of location IDs of the multiple inventory items; generating one or more route segments by combining the one or more base segments with one or more demand points corresponding to a second set of location IDs, wherein the second set of location IDs correspond to inventory items included in customer orders; generating one or more dispatch routes through the one or more route segments based on an optimal routing of resources that maximizes a density metric of the multiple inventory items included in the one or more dispatch routes; and assigning a first user to a combination of the one or more dispatch routes.

Yet another aspect of the present disclosure is directed to a system for segment based approach to routing picking, the system comprising: a memory storing instructions; and at least one processor configured to execute the instructions to perform operations. The operations may comprise: receiving a floorplan of a first set of location IDs, wherein the first set of location IDs correspond to locations of multiple inventory items arranged in a floor; generating one or more base segments that connect the first set of location IDs of the multiple inventory items; receiving one or more urgent items among the multiple inventory items; generating one or more route segments by combining the one or more base segments with one or more demand points corresponding to a second set of location IDs of the one or more urgent items; generating one or more dispatch routes through the one or more route segments, wherein the one or more dispatch routes maximize a density metric, calculated between first adjacent pairs of the second set of location IDs or between second adjacent pairs of one or more route segments; determining a first location of a first user device configured to communicate the first location of a user in possession of the first user device; and generating a signal to the first user device to traverse the one or more dispatch routes, wherein the first user device is located closest to a starting point of the one or more dispatch routes as determined by the first location.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is schematic block diagram illustrating an exemplary embodiment of a computerized system for implementing a segment based VRP model, consistent with the disclosed embodiments.

FIGS. 4A-C are a diagrammatic illustration of an exemplary warehouse, depicting a simplified process for generating base segments, consistent with the disclosed embodiments.

FIG. 5 is a flowchart of an exemplary process for generating an initial batch of base segments, consistent with the disclosed embodiments.

FIG. 6 is a flowchart of an exemplary process for refining the initial batch of base segments, consistent with the disclosed embodiments.

FIGS. 7A-H are a diagrammatic illustration of another exemplary warehouse, depicting a simplified process for generating dispatch routes, consistent with the disclosed embodiments.

FIG. 8 is a flowchart of an exemplary process for generating the dispatch routes using the segment based VRP model, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for using an improved vehicle routing model with the goal of maximizing density using a segment based approach

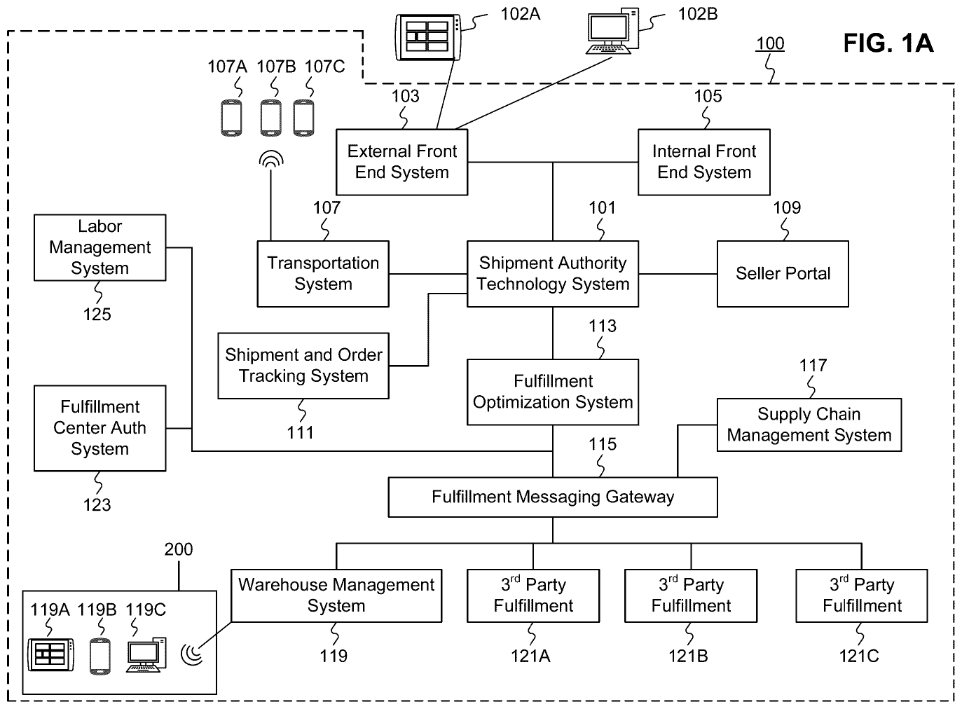

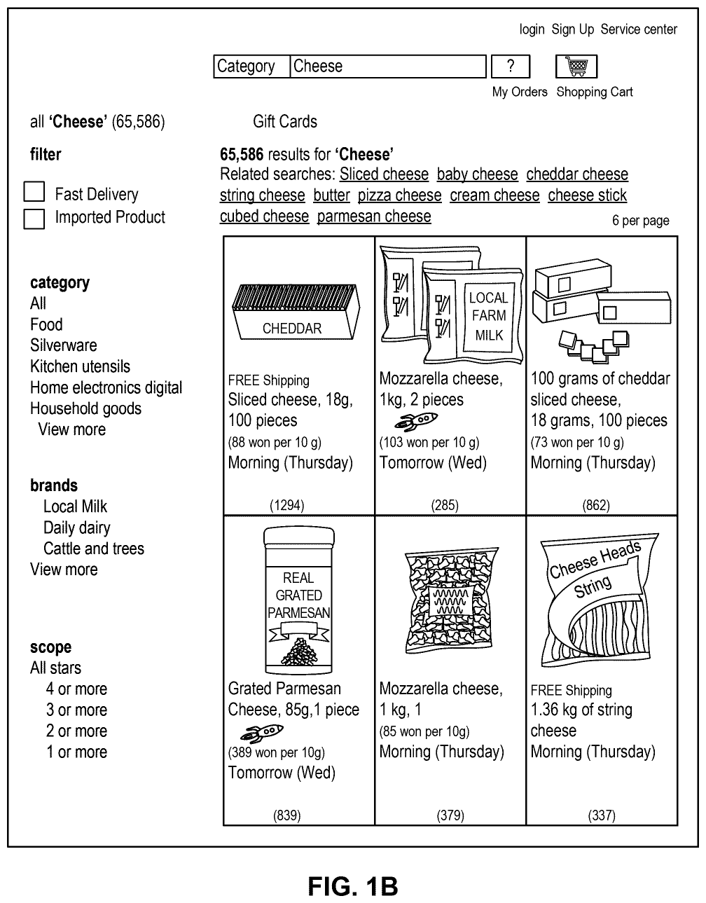

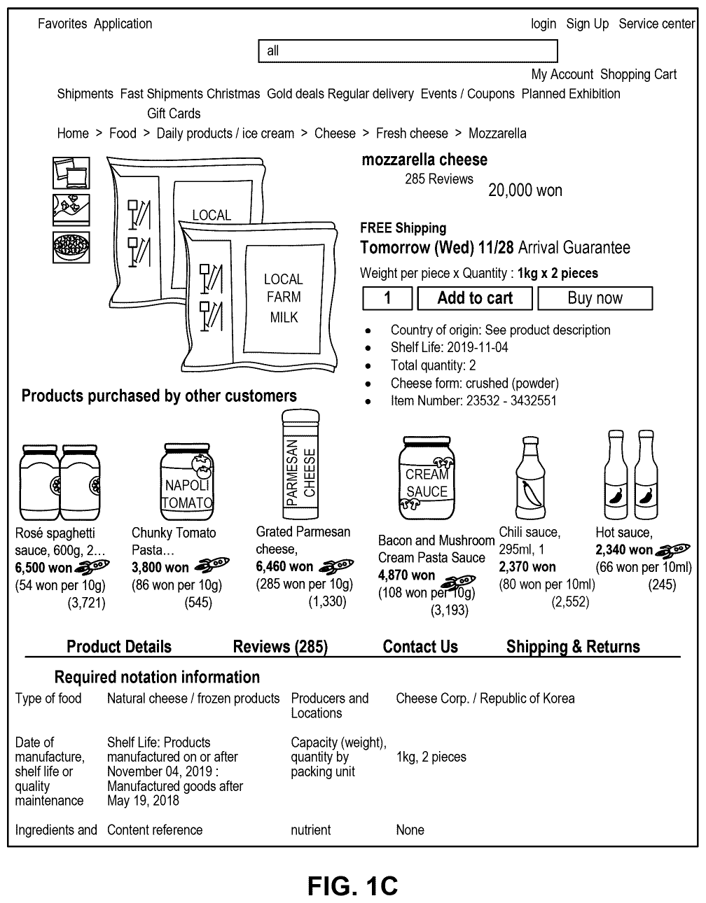

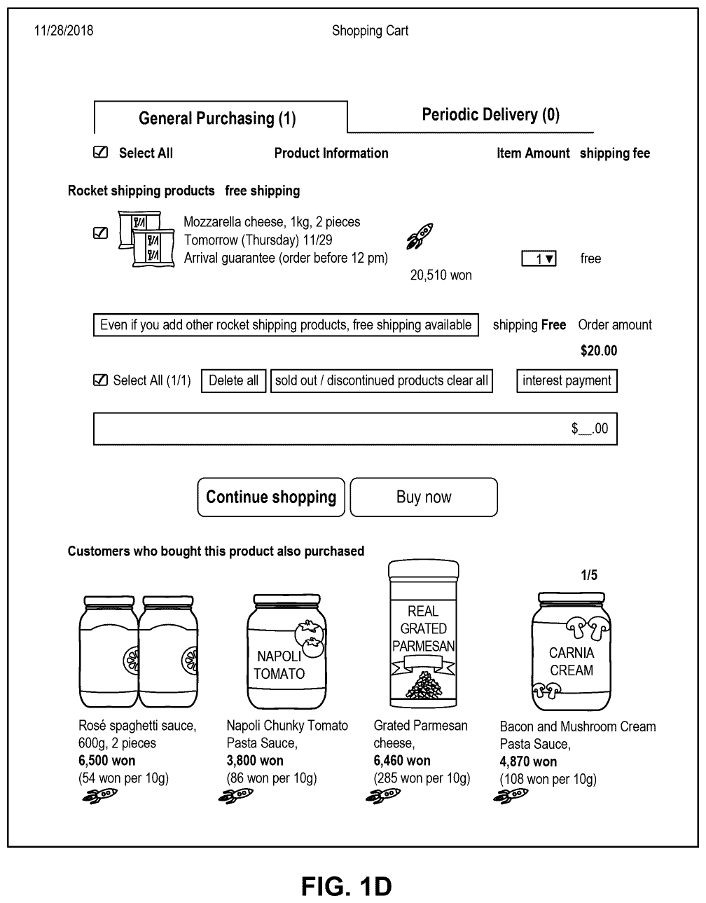

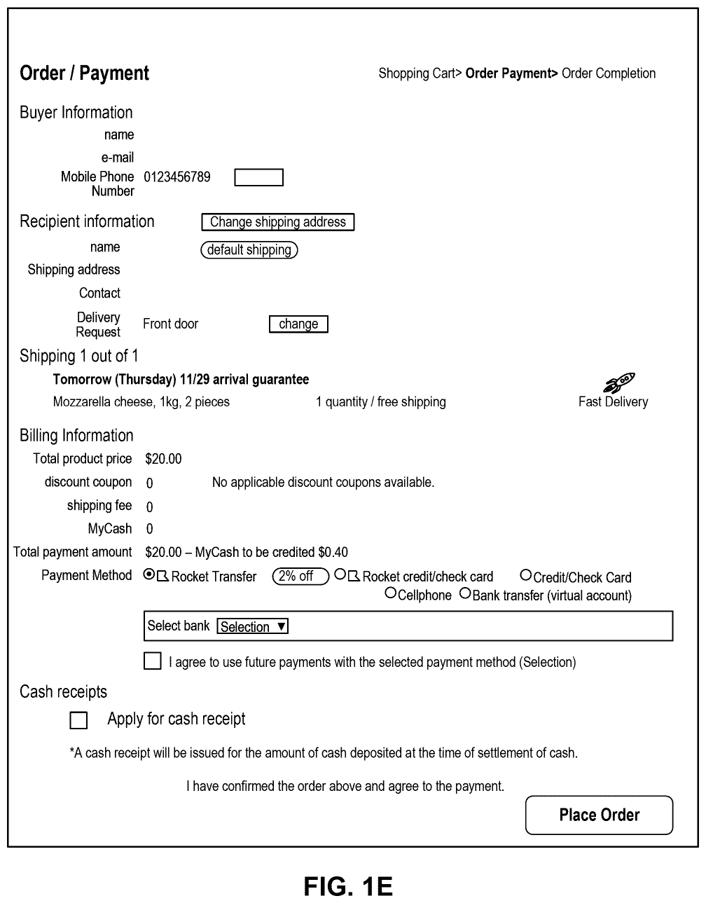

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, Including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

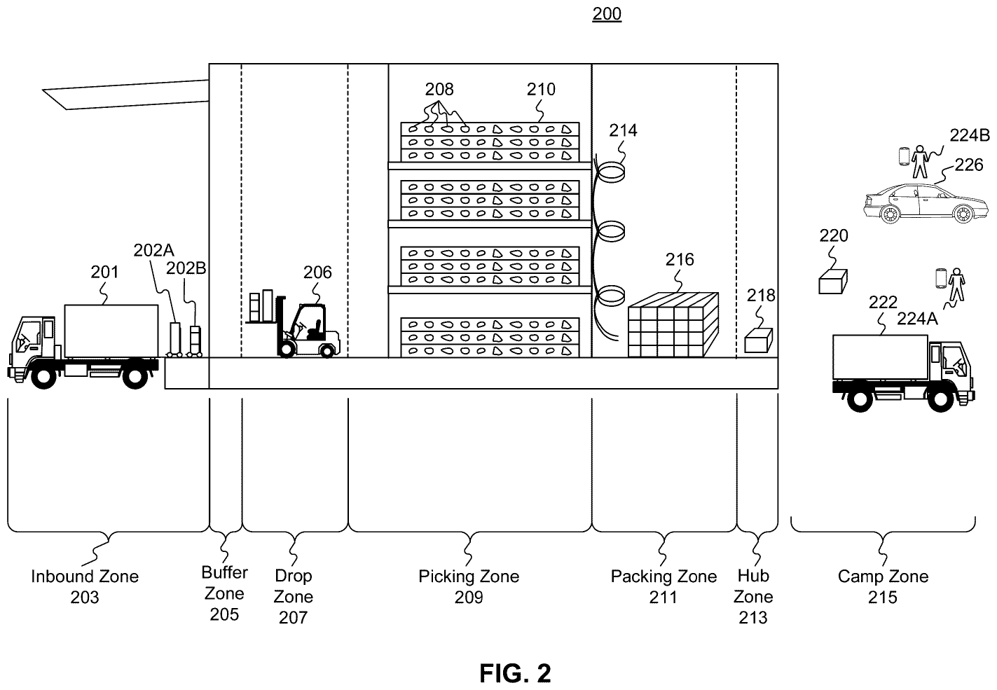

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, or an automated robot or device, or may move the items manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

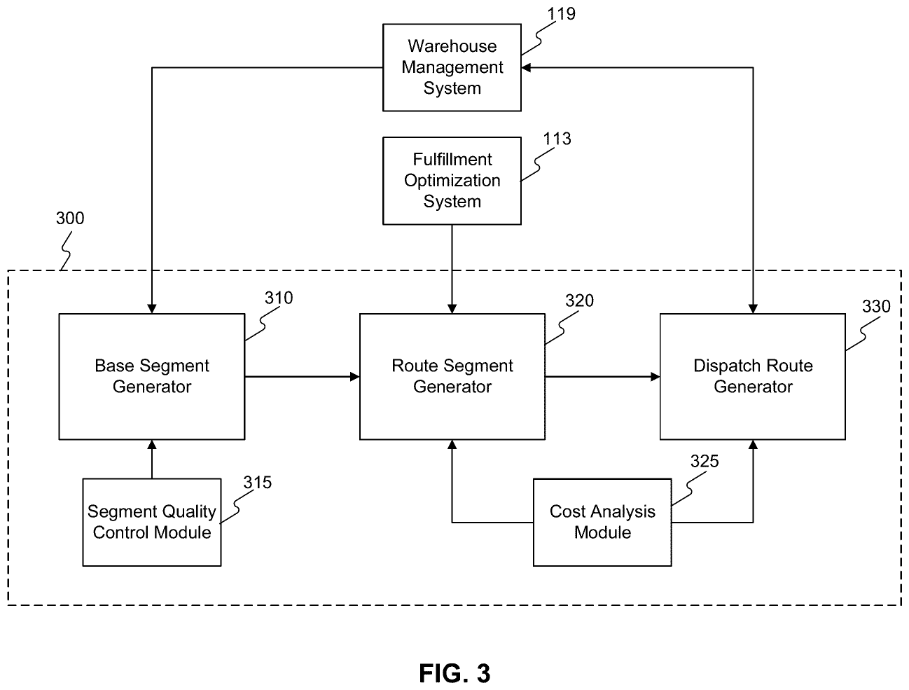

FIG. 3 is schematic block diagram illustrating an exemplary embodiment of a computerized system 300 for implementing a segment based VRP model. Computerized system 300 may comprise one or more component systems, modules, software units, or any combination thereof, each of which may be connected to one another via one or more networks or electrical connections, or may be implemented as software functions or modules. In some embodiments, computerized system 300 may be in communication with one or more systems described above with respect to FIG. 1A. For example, computerized system 300 may be in communication with FO System 113 or WMS 119 to exchange data related to order fulfillment, arrangement of products in picking zone 209, or other information useful for generating segments and applying the segment based VRP model.

Consistent with the disclosed embodiments, the segment based VRP model may offer several advantages over traditional VRP models or other algorithms for optimizing vehicle routing through a series of locations. For example, the segment based VRP model may allow management of multiple depots where vehicles may begin their route; adopt to movement of the depots where the vehicles may begin another route without having to return to the original depot; accommodate fluctuations in the number of depots or vehicles, assign different priorities to different locations; allow optimization of routes based not only on distance but also density and/or capacity; and/or shorten calculation time even in large scale. Embodiments disclosed herein are described in the context of order picking in a warehouse or an FC. One of ordinary skill in the art, however, would recognize the benefits and applicability of the segment based VRP model to other applications, and such applications are also within the scope of the present disclosure.

As used herein, a vehicle may refer to a human or a movable instrument configured to follow a given route to stop at one or more locations assigned to the given route. For example, a vehicle may comprise one or more of boxes, totes, forklifts, carts, handtrucks, or dollies that a picker may use to pick different products in picking zone 209. Additionally or alternatively, a vehicle may comprise autonomous robots or devices that are able to operate without a human operator. In some embodiments, optimized routes, determined as solutions to the segment based VRP model, may be transmitted to mobile devices (e.g., devices 119A-119C) associated with each worker (e.g., picker), where the optimized routes are displayed on the mobile devices to provide instructions to the workers.

Consistent with the disclosed embodiments, the segment based VRP model may achieve the benefits enumerated above by implementing segments to group different locations. For example, in picking zone 209, where a wide variety of products are stored on storage units 210, the segment based VRP model may group the products into smaller subsets and assign a route segment to each subset. Each route segment may traverse each storage unit 210 corresponding to the subset of products. For example, each route segment may map to one aisle within picking zone 209.

Different aspects of the segment based VRP model, including the processes and systems for implementing the segment based VRP model, are described next.

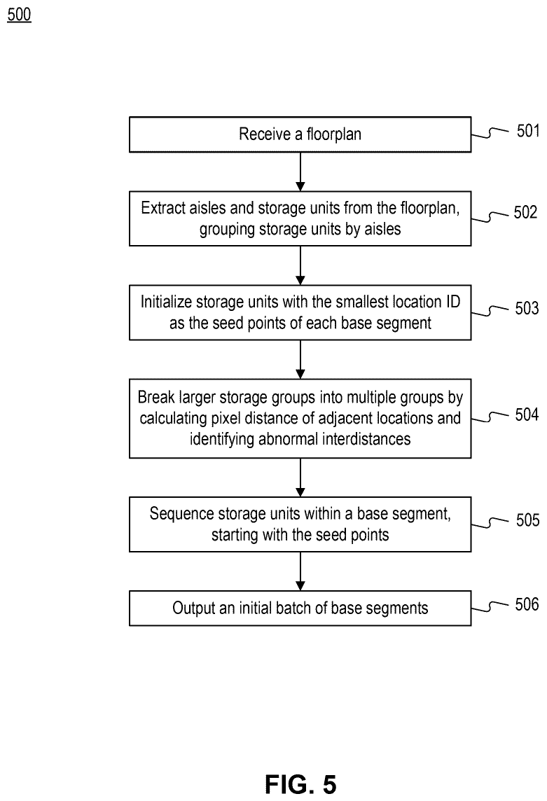

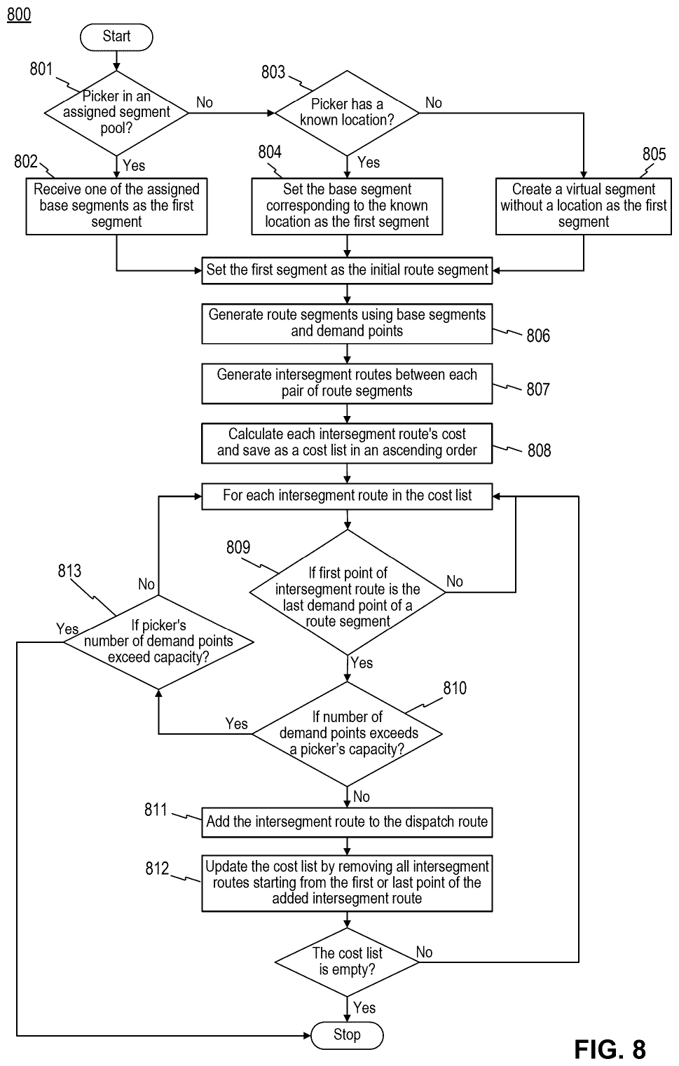

Turning back to FIG. 3, computerized system 300 may comprise a base segment generator 310, a route segment generator 320, and a dispatch route generator 330. In some embodiments, computerized system 300 may also comprise a segment quality control module 315 and a cost analysis module 325. Configurations and functions of each component are described next, while the detailed processes of achieve their functions are described in more detail with respect to at least FIGS. 5 and 8 below.

Base segment generator 310, in some embodiments, may be implemented as a computer system, module, or software unit that generates base segments from a floorplan. As used herein, a base segment may refer to a predetermined sequence of locations through which a vehicle may traverse. For example, base segments may refer to predetermined sequences of locations in picking zone 209 that pickers may go through to pick products from each location associated with a particular base segment. In this way, the segment based VRP model may use base segments as points of consolidation that leads to increasing a number of products that can be picked up in one trip through picking zone 209.

In some embodiments, base segment generator 310 may receive (e.g., from WMS 119) a floorplan or a map of picking zone 209 and generate one or more base segments based on the features (e.g., halls, aisles, doors, walls) depicted therein. Base segment generator 310 may further comprise or be in communication with a segment quality control module 315. Segment quality control module 315 may be implemented as a computer system, module, or software unit that reviews base segments generated by base segment generator 310 and ensure that they cover every location within picking zone 209 and/or ensure that they traverse associated locations most efficiently.

Route segment generator 320, in some embodiments, may be implemented as a computer system, module, or software unit that generates route segments from base segments. As used herein, route segments may refer to a sequence of locations through which a vehicle may traverse, just like base segments, except the locations associated with a particular route segment generated from a base segment is a subset of the locations associated with the same base segment. For example, route segments may refer to sequences of locations that pickers may traverse to pick products associated with customer orders. In some embodiments, route segment generator 320 may be in communication with FO system 113 to receive a list of products and their quantities as ordered by customers.

In further embodiments, route segment generator 320 may comprise or be in communication with a cost analysis module 325. Cost analysis module 325 may be implemented as a computer system, module, or software unit that determines costs associated with traversing different ordered combinations of locations associated with a particular route segment and determines optimal sequences of locations to traverse that minimize the cost. In some embodiments, cost analysis module 325 may determine and take into consideration data such as density of products to be picked (i.e., number of products located within a unit of area), distance between products to be picked, carrying capacity of vehicles, total distance to be traveled, type of vehicle, or the like.

Dispatch route generator 330, in some embodiments, may be implemented as a computer system, module, or software unit that generates dispatch routes from route segments. As used herein, dispatch routes may refer to a sequence of one or more route segments that a vehicle may traverse in one trip. For example, dispatch routes may refer to sequences of route segments, and thus the locations associated therewith, that pickers may traverse in one trip, starting with an empty vehicle and ending after having traversed all locations associated with a dispatch route or after having filled the capacity of the vehicle.

In some embodiment, dispatch route generator 330 may also comprise or be in communication with cost analysis module 325. As described above in relation to route segment generator 320, cost analysis module 325 may determine costs associated with traversing different ordered combinations of route sequences and determine optimal sequences of dispatch routes that minimize the cost. In some embodiments, cost analysis module 325 may determine and take into consideration data such as density of products to be picked (i.e., number of products located within a unit of area), distance between products to be picked, carrying capacity of vehicles, total distance to be traveled, type of vehicle, current (or last known) location of vehicles, potential end locations of dispatch routes, or the like.

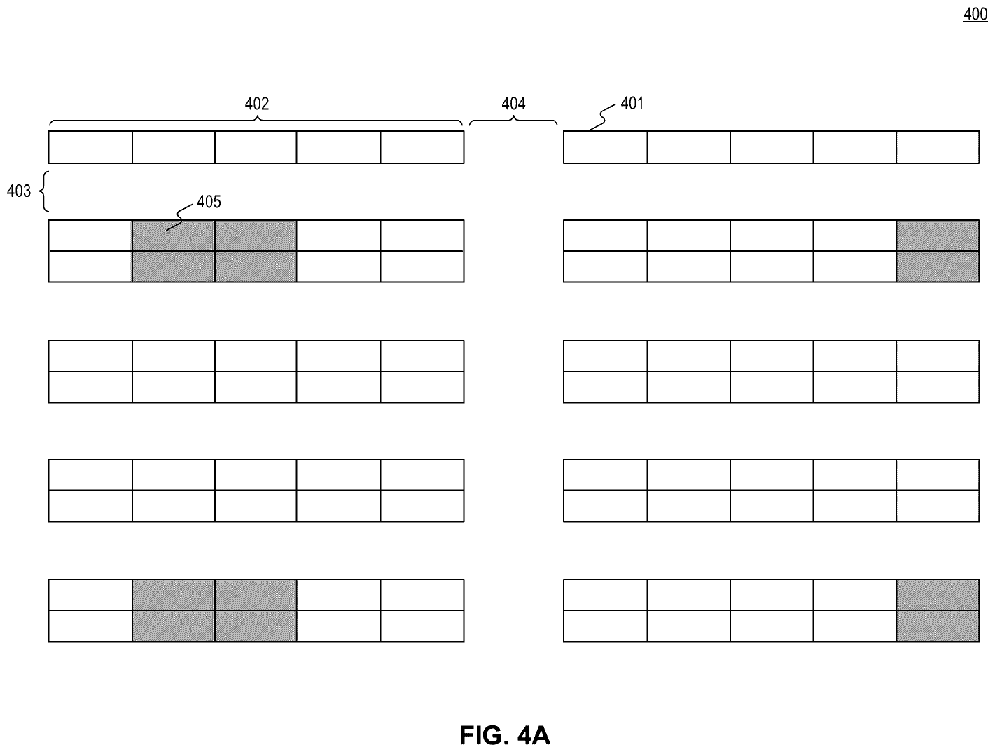

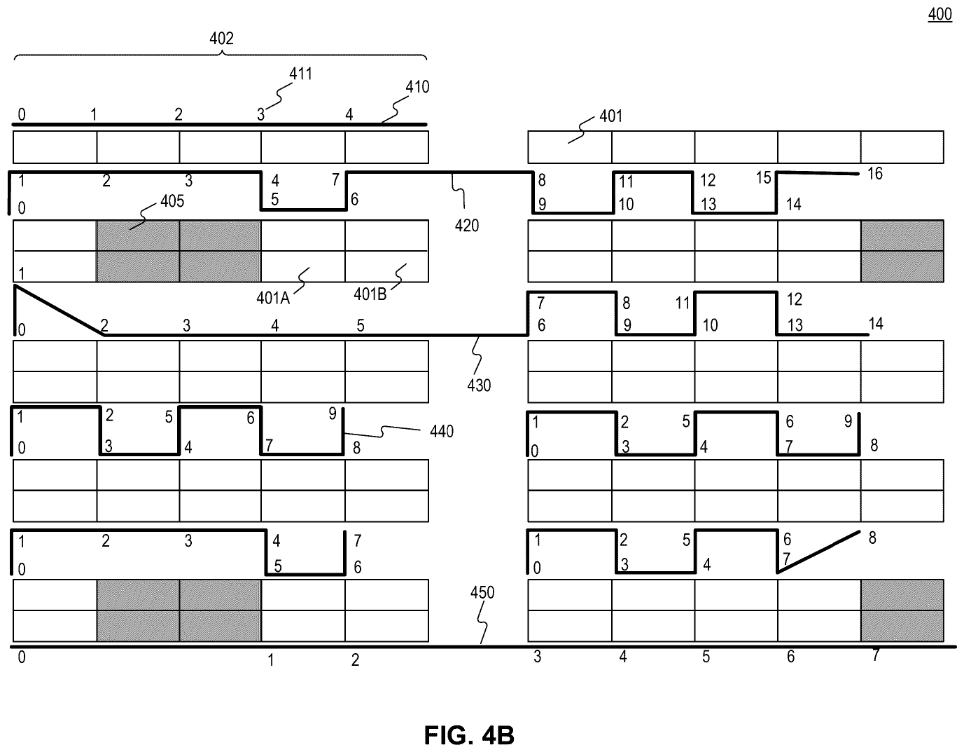

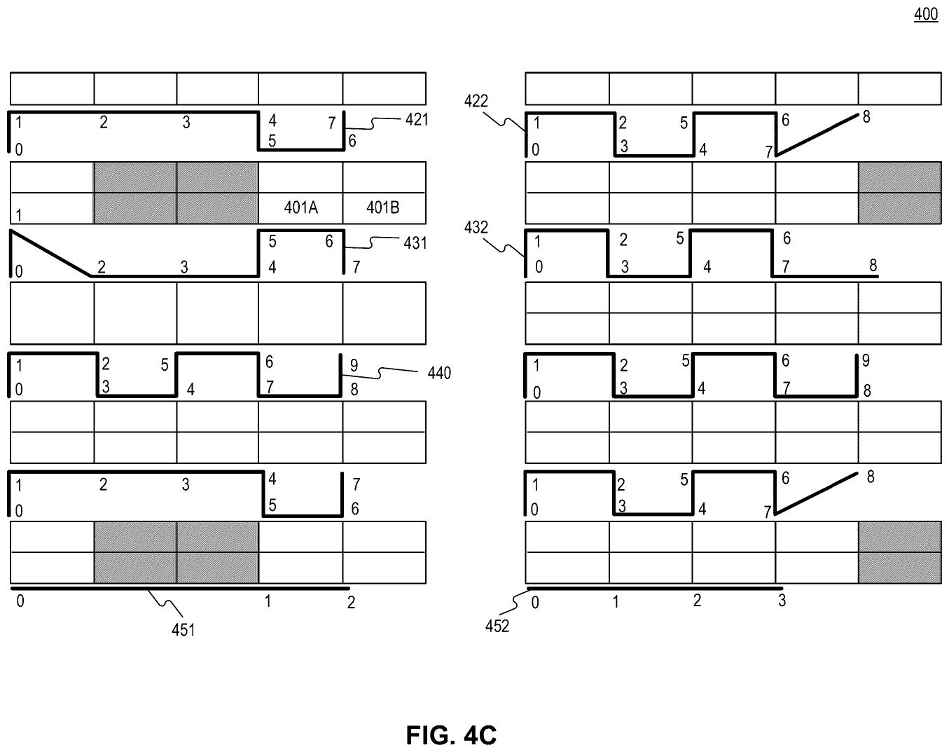

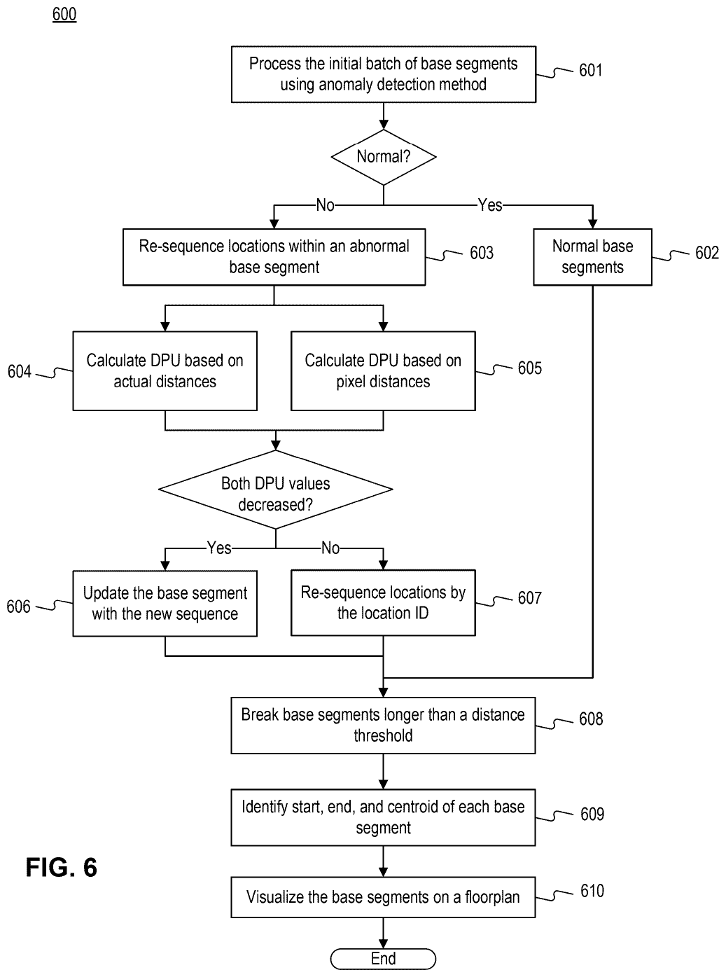

FIGS. 4A-C are a diagrammatic illustration of an exemplary warehouse floor 400 (e.g., picking zone 209), depicting a simplified process for generating base segments. A more detailed process for generating base segments is described below with respect to FIGS. 5 and 6. The arrangement of different elements illustrated in FIGS. 4A-C may be an exemplary representation of warehouse floor 400, as constructed by base segment generator 310. While embodiments disclosed herein are described in the context of FC 200 or a warehouse, the embodiments may also be applicable to any other context, and warehouse floor 400 may also comprise more than one floor or include floors in more than one building.

Referring to FIG. 4A, warehouse floor 400 may comprise one or more storage units 401 arranged in rows of storage groups 402. Storage groups 402 may be separated by aisles 403 or hallways 404. Some sections of storage groups 402 may be blocked off or occupied by structural elements (e.g., supporting columns), as represented by barriers 405. Storage units 401 may comprise one or more of physical shelving, bookshelves, boxes, totes, refrigerators, freezers, cold stores, or the like, as described above with respect to FIG. 2. Each storage unit 401 may be associated with a location identification code (ID), which may be assigned sequentially from one storage unit 401 to a neighboring unit. These location IDs may correspond to the barcodes placed at each storage unit 401, as also described above with respect to FIG. 2.

Referring to FIG. 4B, base segment generator 310 may be configured to receive a digitized floorplan or map of warehouse floor 400, extract arrangement of spatial elements such as storage units 401, storage groups 402, aisles 403, hallways 404, and/or barriers 405. Base segment generator 310 may then generate base segments (e.g., 410, 420, 430, 440, 450) configured to traverse groups of storage units 401. For example, base segment 410 is configured to traverse the five storage units 401 in the top left storage group 402. In some embodiments, each base segment may comprise a location sequence 411 of the storage units 401 associated with the base segment, where each location sequence 411 comprises a starting position (e.g., “0” of base segment 410) and an end position (e.g., “4” of base segment 410). In some embodiments, base segments may not be associated with locations represented by barrier 405, as illustrated by base segment 420 that do not extend down to barrier 405.

In some embodiments, positions of base segments relative to storage groups 402 may indicate the side from which a vehicle is intended to access each associated storage unit 401. For example, a first vehicle assigned to base segment 410 may be instructed to access storage group 402 from one side of storage group 402, while a second vehicle (which may be the same as the first vehicle) assigned to base segment 420 may be instructed to access storage group 402 from the other side of storage group 402.

Having said that, some base segments initially generated by base segment generator 310 may be erroneous or less than optimal. For example, base segment 410 may be erroneous because it shows storage group 402 as being accessible from the top side (i.e., from the left-hand side of storage group 402 as seen from a person standing on the left edge of storage group 402, looking down aisle 403). Base segment 420 may be less than optimal because it is too long. Base segment 430 may be erroneous because it omitted storage units 401A and 401B. Base segment 450 may be erroneous because it is associated with a barrier 405 at the right-most end as location sequence 7, and it may be less than optimal because it is too long. It may not be an error for base segment 450 to show the bottom row of storage group 402 as being accessible from the bottom side, because the top side of the bottom row is blocked off by another row of storage units 401.

In some embodiments, segment quality control module 315 may be configured to detect erroneous or less than optimal base segments and modify the identified base segments. For example, FIG. 4C shows a corrected and/or optimized set of base segments, base segment 420 may be divided into two segments-base segments 421 and 422. Base segment 430 may be divided into two segments-base segments 431 and 432—where base segment 431 correctly associated with storage units 401A and 401B. Base segment 440 may be unchanged because it did not contain any errors or was already optimal. Base segment 450 may be divided into two segments-base segments 451 and 452—where base segment 452 is no longer associated with barrier 405 at the right-most end.

FIG. 5 is a flowchart of an exemplary process 500 for generating an initial batch of base segments. In some embodiments, this initial batch of base segments may be erroneous in one or more aspects or be less than optimal for one or more reasons like base segments 410, 420, 430, and 450 of FIG. 4B. Process 500 may be performed by a computerized system such as base segment generator 310.

At step 501, base segment generator 310 may receive a floorplan of warehouse floor 400. The floorplan may take the form of a scanned image of a map, a digital file format suitable for illustrating a layout of warehouse floor 400 (e.g., vector or raster GIS (geographic information systems) files, geographic database file formats, relational database management system files), a three-dimensional scan or model of warehouse floor 400 (e.g., LiDAR files, CAD files), or any other file configured to convey locations of storage units 401, aisles 403, hallways 404, and/or barriers 405. In some embodiments, such data may be received from WMS 119.

At step 502, base segment generator 310 may extract locations of storage units 401, storage groups 402, aisles 403, hallways 404, and/or barriers 405 from the floorplan, forming a diagrammatic representation of warehouse floor 400 as shown in FIG. 4A. In some embodiments, base segment generator 310 may comprise an image recognition module (not shown) configured to recognize the different types of elements found in the floorplan. For example, the image recognition module may be configured to recognize particular patterns or symbols in the floorplan as corresponding to storage units 401, storage groups 402, aisles 403, hallways 404, or barriers 405. In some embodiments, the diagrammatic representation may be true to scale, so as to allow route segment generator 320 and dispatch route generator 330 make accurate calculations of costs.

In further embodiments, base segment generator 310 may associate each storage unit 401 with their corresponding location IDs and determine or assign characteristics of each storage unit 401. For example, base segment generator 310 may determine, from data received from WMS 119, characteristics such as the products that are stored at each storage unit 401, the direction in which storage unit 401 is accessible, Cartesian coordinates of storage unit 401 with respect to a predetermined point in warehouse floor 400, or the like. In some embodiments, base segment generator 310 may group storage units 401 in the same aisle 403 into storage groups 402 instead of extracting them from the floorplan. Determination of disclosed characteristics may be performed manually or automatically using image recognition algorithms (implemented in, e.g., the image recognition module described above), in which case any errors may be corrected by segment quality control module 315. Furthermore, each storage group 402 may serve to limit the number of storage units 401 associated with each base segment, where storage groups 402 may have a one-to-one correspondence with base segments.

At step 503, base segment generator 310 may, among storage units 401 in each storage group 402, initialize storage unit 401 with the smallest location ID as the seed point of each base segment. Because locations IDs are assigned sequentially from one storage unit 401 to a neighboring unit, setting the storage unit 401 with the smallest location ID in each storage group 402 may ensure that the location sequence of each base segment begins from either end of the base segment. Other initialization methods for setting the seed point are also possible and are within the scope of the disclosed embodiments.

At step 504, base segment generator 310, with or without the aid of segment quality control module 315, may break larger storage groups 402 into smaller groups based on aisles 403 and/or hallways 404. In some embodiments, larger storage groups 402 may span across more than one aisle 403 or one or more hallways 404, in which case base segment generator 310 may split such storage groups 402 into multiple groups at the location(s) of the aisles 403 or hallways 404. For example, base segment 420 spans across two aisles 403 (one in the left column and the other in the right column of storage groups 402) and one hallway 404 and may be split into smaller base segments 421 and 422. Additionally or alternatively, base segment generator 310 may be configured to identify larger storage groups 402 based on distance per unit (DPU) of products or storage units 401. For example, a large base segment that spans across hallway 404 may have an abnormally large DPU due to the gap of space, and thus larger interdistance, between storage units 401 located on one side of hallway 404 and the other storage units 401 located on the other side.

In some embodiments, base segment generator 310 may identify larger storage groups 402 by calculating pixel distance of adjacent storage units 401 and/or identifying abnormal interdistances between storage units 401 that are greater than a predetermined threshold. In further embodiments, base segment generator 310 may identify abnormal interdistances using a Gaussian mixture model that has been improved by adding a quantile filter. For example, adding a quantile filter to a Gaussian mixture model can improve the model's performance by removing outliers from the dataset before fitting them to the model. This may lead to more accurate estimates of the model parameters and a better fit to the underlying data distribution, which can be analyzed to determine which interdistances are normal versus abnormal.

At step 505, base segment generator 310 may sequence storage units 401 within a base segment, starting with the seed points set at step 503 above. Sequencing may thus be determined with a fixed start and unfixed end point, where each storage unit 401 in each base segment is assigned a sequence number 411. Alternatively, base segment generator 310 may begin the sequencing from a storage unit 401 located at any extremes of storage group 402 associated with the base segment. For example, base segment generator 310 may begin sequencing from either the left-most or the right-most storage unit 401 as the start point or any of storage units 401 located at a corner of storage group 402.

In some embodiments, sequencing storage units 401 within each base segment may be likened to a simpler VRP, where a vehicle must traverse all associated storage units 401 starting from the seed point and within the shortest distance possible. To this end, base segment generator 310 may take into consideration various factors and constraints for optimizing the sequence. The factors and constraints may include, for example, DPU, hourly throughput (HTP) of vehicles traversing the sequence, maneuverability of vehicles (e.g., a vehicle may be unable to make sharp turns), directionality of aisles 403 or hallways 404, locations of barriers 405, or the like. An optimized sequence for a base segment may be one that minimized traversing time by a vehicle, increased density of products located within the base segment, and increased HTP by minimizing interference with other vehicles or workflows.

At step 506, base segment generator 310 may output or store an initial batch of base segments generated by the steps described above. In some embodiments, base segment generator 310 may record DPU of each base segment along with the initial batch for future reference by other computerized systems such as route segment generator 320 and/or dispatch route generator 330.

FIG. 6 is a flowchart of an exemplary process 600 for refining the initial batch of base segments generated by base segment generator 310. Process 600 may be performed by a computerized system such as base segment generator 310, segment quality control module 315, or by a combination of the two.

At step 601, segment quality control module 315 may initiate the process of analyzing the initial batch of base segments using anomaly detection method enabled by segment quality control module 315. Base segments that are determined to be normal, non-erroneous, or already optimized may skip to step 608 at step 602. In some embodiments, segment quality control module 315 may attempt to identify abnormal base segments using the Gaussian mixture model and quantile filter again, where outlier base segments with DPU values that depart significantly from the others are considered abnormal. Any base segment identified here may be split into smaller segments via a process similar to those described above with respect to step 504.

Additionally or alternatively, segment quality control module 315 may resequence the other base segments (i.e., abnormal, erroneous, or non-optimized) at step 603. Compared to the initial sequencing performed at step 505 described above, resequencing performed at step 603 may be based on DPU calculated using actual distance, at step 604, and pixel distance, at step 605. As used herein, actual distance may refer to the distance that would be traveled if the base segment were traversed on warehouse floor 400, and pixel distance may refer to the number of pixels traversed by the base segment on the floorplan received at step 501, converted to a distance unit based on scale.

After resequencing, segment quality control module 315 may compare the two DPUs of the resequenced base segment, calculated based on actual distance and pixel distance, and update the initial base segment with the resequenced base segment, at step 606, if both DPUs have decreased. Otherwise, segment quality control module 315 may resequence the base segment yet again by location ID and replace the initial base segment with the new base segment at step 607. Resequencing by location ID may comprise ordering storage units 401 of the base segment in the order of increasing or decreasing location ID based on the location ID set as the seed point.

At step 608, segment quality control module 315 may further refine the base segments by breaking up base segments longer than a distance threshold, similar to how larger storage groups 402 were broken up at step 504 above.

Thereafter, base segment generator 310 may continue process 600 by identifying the starting point, end point, and centroid of each base segment at step 609 and visualizing the base segments on a floorplan with sequence numbers 411 at step 610, as depicted in FIG. 4C. As used herein, the centroid of a base segment may refer to the center of where storage units 401 are located within the base segment. The centroid may be determined in a two-dimensional Cartesian coordinate defined with respect to a predetermined point in the floorplan or in a one-dimensional scale defined with respect to the sequence numbers of the base segment.

In some embodiments, process 600 may further comprise manual adjustment of one or more base segments, where a user may adjust base segments stored in a network database via, e.g., internal front end system 105. For example, segment quality control module 315 may be configured to allow the user to resequence a base segment, remove a storage unit 401 from a base segment, add a storage unit 401 to a base segment, add a new base segment, remove an existing base segment, or any other adjustment that may be appropriate. In some embodiments, segment quality control module 315 may also allow the user to adjust any aspect of data extracted from the floorplan at step 502, including storage units 401, storage groups 402, aisles 403, hallways 404, and barriers 405. For example, the user may be allowed to set the side in which a storage unit 401 is accessible, set directionality of aisles 403 or hallways 404, add, modify, or remove barriers 405, or the like.

In some embodiments, segment quality control module 315 may perform process 600 periodically or upon user demand to regenerate base segments. Base segments may need to be regenerated or redefine to reflect changes in warehouse floor 400 such as rearrangement of one or more storage units 401, temporary or permanent blockage of certain areas, or any other change that affects how a vehicle may traverse any of the previously generated set of base segments. In further embodiments, segment quality control module 315 may also be configured to identify errors in the floorplan and generate a notification to the user concerning the error, allowing the user to update the floorplan.

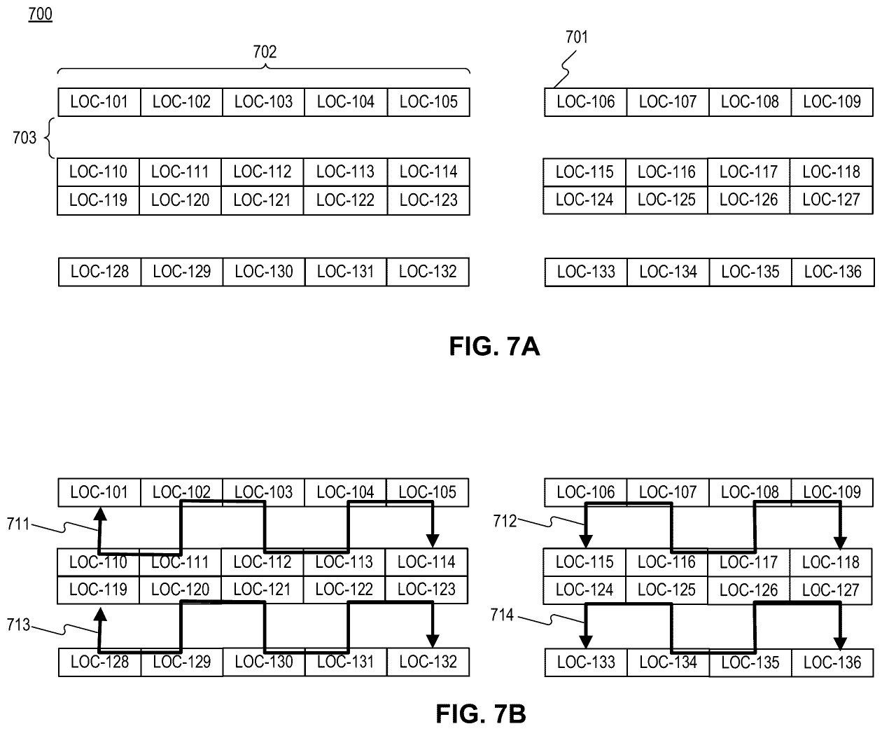

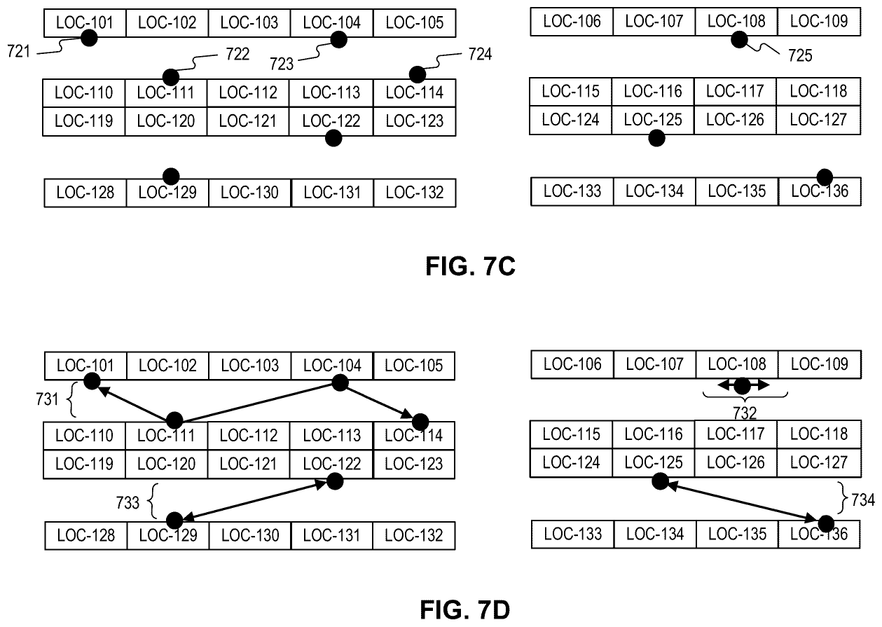

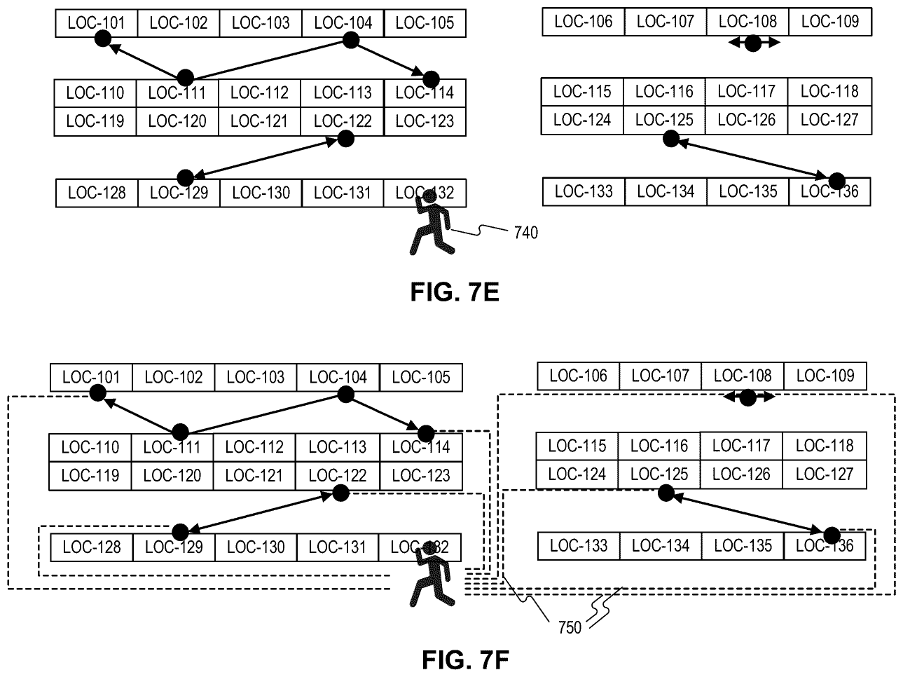

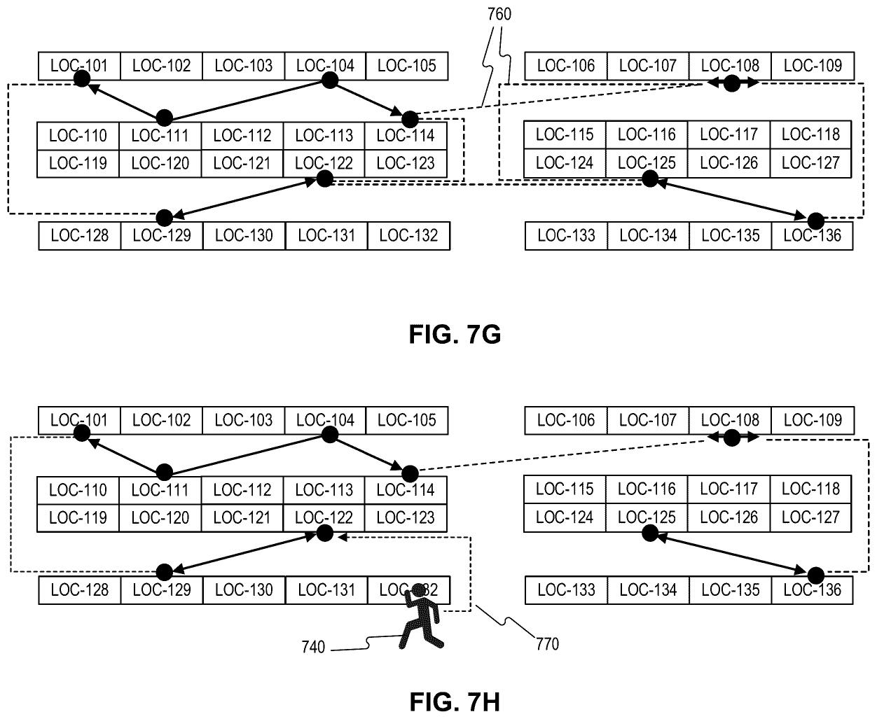

FIGS. 7A-H are a diagrammatic illustration of another exemplary warehouse floor 700 (e.g., picking zone 209), depicting a simplified process for generating dispatch routes. A more detailed process for generating dispatch routes is described below with respect to FIG. 8. While embodiments disclosed herein are described in the context of FC 200 or a warehouse, the embodiments may also be applicable to any other context, and warehouse floor 400 may also comprise more than one floor or include floors in more than one building.

Referring to FIG. 7A, warehouse floor 700 may comprise features similar to warehouse 400, such as storage units 701, storage groups 702, and aisles 703. Other features such as hallways 404 and barriers 405 are not shown for brevity. Each storage unit 701 is associated with a location ID (e.g., LOC-101, LOC-102 . . . ). FIG. 7B shows base segments 711-714, each configured to traverse a set of storage units 701 grouped by aisles 703. In some embodiments, base segments 711-714 may be generated consistent with other embodiments of this disclosure (e.g., as discussed above with respect to FIG. 5).

FIG. 7C shows the same warehouse floor 700 with demand points 721-725. As used herein, demand points may refer to specific storage units 701 where products included customer orders are located and need to be picked. For example, all storage units 701 shown in FIG. 7C may each store household items such as glass cleaners, disinfectant wipes, laundry detergents, fabric softeners, trash bags, paper towels, toilet papers, dish soaps, dishwasher detergents, air fresheners, light bulbs, AA batteries, extension cords, power strips, or the like, in sequence starting from storage unit 701 corresponding to LOC-101. A customer may place an order for a glass cleaner, a fabric softener, a dish soap, a light bulb, and a power strip. Demand points 721-724 may correspond to storage units 701 storing the ordered products.

In some embodiments, demand points 721-724 may correspond to products ordered by one or more customers in two or more orders, as opposed to being associated with a single order by one customer. For example, the products listed above—a glass cleaner, a fabric softener, a dish soap, a light bulb, and a power strip—may belong to more than one order but consolidated into one picking list queue for the purposes of determining demand points 721-724 and generating route segments. The ordered products may be combined into a picking list queue through a process called singulation, as disclosed in at least U.S. patents application Ser. No. 16/416,909 (filed on May 20, 2019); Ser. No. 16/876,794 (filed on May 18, 2020); Ser. No. 16/885,712 (filed on May 28, 2020); Ser. No. 16/887,598 (filed on May 29, 2020); Ser. No. 16/888,022 (filed on May 29, 2020); and Ser. No. 16/926,413 (filed on Jul. 10, 2020), contents of all of which are incorporated herein by reference in their entireties. In some embodiments, the picking list queue may be a dynamic list maintained by FO system 113, where ordered products, their quantities, and priorities are constantly changed (e.g., added when a new order is placed, removed when an order is cancelled, removed when products from the list are associated with a base segment to generate a route segment, or added back when a route segment is cancelled).

FIG. 7D shows route segments 731-734, each of which connects demand points 721-725 that fall within corresponding base segments. For example, route segment 731 may connect demand points 721-724, which correspond to storage units 701 associated with base segment 711. In other words, route segments 731-734 may be modified versions of base segments 711-714, where base segments 711-714 traverse all storage units 701 associated with each base segment and route segments 731-734 only traverse storage units 701 that correspond to the demand points 721-725. A route segment (e.g., 731) may thus comprise a sequence of demand points (e.g., 721-724), where demand points at either ends (e.g., 721 and 724) are considered start and end points. Route segments may also be bidirectional, where the start and end points may be interchangeable. In some embodiments, a route segment may be identical to the corresponding base segment where demand points correspond to all storage units 701 associated with the base segment. A route segment (e.g., 732) may be a single point or a single storage unit 701, where only one demand point (e.g., 725) falls within a base segment (e.g., 712).

FIG. 7E shows a picker 740 at a particular location within warehouse floor 400 (e.g., next to storage unit 701 associated with LOC-132. This location may be the current location of one or more devices 119A-119C of picker 740 as tracked by GPS, Bluetooth beacons, or other location protocols; the last known location based on a work log maintained by WMS 119 (e.g., based on a scan event from a device 119A-119C indicating a most recently scanned identifier for a location in FC 200); or an arbitrary location within warehouse floor 400. In some embodiments, picker 740's location may be set or tracked using different methods. For example, at the beginning of a shift for picker 740, picker 740 may indicate, using a mobile device such as devices 119A-119C, that they are available. In such cases, picker 740's location may be set to being unknown. In another example, picker 740's device may prompt picker 740 to scan a location ID nearest to their current location, and the location of the scanned location ID may be set as picker 740's location. In yet another example, picker 740's location may be set as the last demand point of the last route segment that they traversed or the drop-off location of the picked products.

FIG. 7F shows potential presegment routes 750, connecting the location of picker 740 and starting or end points of route segments 731-734. Presegment routes 750 may represent potential routes that picker 740 may take in order to move to one of the available route segments. Dispatch route generator 330 may use presegment routes 750 to determine the first route segment that picker 740 should traverse.

Similarly, FIG. 7G shows potential intersegment routes 760, connecting the starting and end points of route segments 731-734. Travel routes 750 may represent potential routes that picker 740 may take after finishing one route segment and moving to a next route segment. Dispatch route generator 330 may use intersegment routes 760 to determine sequences of route segment that picker 740 should traverse. While only a subset of potential intersegment routes 760 are shown, dispatch route generator 330 may consider all possible combinations of intersegment routes 760, such as one connecting route segments 731 and 734.

FIG. 7H shows a completed dispatch route 770 to be traversed by picker 740. Dispatch route 770 may comprise a combination of presegment route 750 and/or intersegment route 760, which picker 740 is instructed to traverse and pick products from demand points. In some embodiments, dispatch route 770 may further comprise a postsegment route (not shown) that connects the last demand point of a dispatch route to a drop-off point (not shown), where picker 740 is instructed to drop off the picked products. The picked products may then be transported to packing zone 211 via transport mechanism 214.

FIG. 8 is a flowchart of an exemplary process 800 for generating the dispatch routes using the segment based VRP model. Process 800 may be performed by a computerized system such as route segment generator 320 and/or dispatch route generator 330. In some embodiments, route segment generator 320 and/or dispatch route generator 330 may repeat process 800 for each picker 740 available for picking.

Process 800 may begin by setting a first segment as an initial route segment based on picker 740's assigned workplace or location. Similar to how base segment generator 310 initially set a storage unit 401 as a seed point of a base segment, as described above, dispatch route generator 330 may initialize each dispatch route with the first segment as a starting point.

In some embodiments, at step 801, dispatch route generator 330 may query WMS 119 for information on whether picker 740 is in an assigned route segment pool, where picker 740 is assigned to a pool comprising a set of route segments corresponding to a limited set of base segments. For example, picker 740 may be assigned to a pool corresponding to base segments that traverse refrigerated products aisles. In such situation, dispatch route generator 330 may receive one of the assigned route segments as the first segment for picker 740 at step 802 and set it as the initial route segment.

Alternatively, if picker 740 is not assigned to a pool of route segments, dispatch route generator 330 may, at step 803, query WMS 119 for information on whether picker 740 has a known location in warehouse floor 400. Dispatch route generator 330 may, in some embodiments, determine picker 740's location by querying WMS 119 or one or more devices 119A-119C associated with picker 740. As described above with respect to FIG. 7E, determining picker 740's location may comprise receiving the current location of picker 740 as tracked and reported by devices 119A-119C using GPS, Bluetooth beacons, or other location protocols; instructing picker 740 to scan any location ID near picker 740's current location and receiving the location corresponding to the scanned location ID; and/or receiving the last known location based on a work log maintained by WMS 119.

If picker 740's location is known or determined as described above with respect to FIG. 7E, dispatch route generator 330 may, at step 804, set the route segment corresponding to picker 740's known location as the first segment. Still further, if picker 740 is not assigned to a pool of route segments and picker 740's location is not known, dispatch route generator 330 may, at step 805, create a virtual segment without a location as the first segment.

Thereafter, at step 806, route segment generator 320 may generate route segments using demand points. In some embodiments, route segment generator 320 may receive or retrieve demand points from a list of products that are queued for picking. The demand points may be limited to the base segment currently set as the initial route segment. In further embodiments, route segment generator 320 may filter the list of products based on urgency before receiving or retrieving the demand points. For example, route segment generator 320 may receive or retrieve demand points of products that are tagged as being urgent, which may allow route segment generator 320 to generate route segments, and subsequently dispatch routes, that only focus on picking the urgent products. Using various levels of urgency or other categories of filtering products are also possible and are within the scope of the disclosed embodiments.

Having received or retrieved demand points, route segment generator 320 may generate route segments from corresponding base segments by removing storage units 701 not corresponding to the demand points and reconnect the remaining storage units 701. For example, if a base segment comprised storage units 701 having location IDs LOC-125, LOC-126, LOC-127, connected in sequence, and demand point corresponded with only LOC-125 and LOC-127, route segment generator 320 may remove LOC-126 and connect LOC-125 and LOC-127 in a straight line.

At step 807, cost analysis module 325 may generate intersegment routes 760 between each pair of route segments. As described above, intersegment routes 760 may be generated between every possible combination of route segments.

At step 808, cost analysis module 325 may calculate each intersegment route 760's cost and save them as an ordered list. In some embodiments, the costs of intersegment routes 760 may be listed in the order of increasing cost, so that dispatch route generator 330 may consider and add intersegment routes 760 with the lowest cost to the dispatch route for picker 740 first.

In some embodiments, costs of intersegment route 760 may be defined as the following formula:

cost(i,j)=1/cross density(i,j)+1/inner density(j)+1/end extremity density(j)

where i refers to the first route segment in a pair of route segments and j refers to the second route segment therein, where a dispatch route progresses from the first route segment to the second route segment.

As used herein, cross density may refer to the density between the last demand point of the first route segment and the first demand point of the second route segment. The shorter the distance between the two route segments, the higher is the cross density, which leads to lower cost. Inner density may refer to the density of the second route segment, where higher density indicates that demand points of the second route segments are located closer to each other. Higher inner density would allow dispatch route generator 330 to prioritize route segments with more products to be picked and thus increase hourly throughput (HTP) of pickers 740. End extremity density may refer to the density around the last demand point of the second route segment. Higher end extremity density may allow dispatch route generator 330 to prioritize route segments that end in the vicinity of high-density area, thus guiding picker 740 to gradually move towards a high-density area even if the immediately following route segment has an inner density.

Next, for each intersegment route 760 in the cost list, cost analysis module 325 and dispatch route generator 330 may confirm, at step 809, validity of intersegment route 760 by determining that the first point of intersegment route 760 is indeed the last demand point of the immediately preceding route segment. If so, dispatch route generator 330 may also confirm, at step 810, that the next route segment at the end of intersegment route 760 will not cause picker 740 to exceed capacity. If not, dispatch route generator 330 may proceed, at step 811, to add intersegment route 760 to the dispatch route. Dispatch route generator 330 may also update the cost list, at step 812, by removing all intersegment routes 760 that are no longer possible, such as those that start from the first or the last point of intersegment route 760 added to the dispatch route at step 811. Dispatch route generator 330 may then proceed to the next intersegment route 760 in the cost list if any remain or stop if otherwise.

Turning back to step 810 where dispatch route generator 330 confirmed whether adding intersegment route 760 would lead to exceeding a picker 740's capacity, dispatch route generator 330 may also confirm whether picker 740 has already reached their capacity at step 813. If not, dispatch route generator 330 may proceed to the next intersegment route 760 in the cost list so that any intersegment route 760 with a smaller number of demand points could be added to the dispatch route without exceeding the picker 740's capacity. If the picker 740's capacity is already exceeded, dispatch route generator 330 may stop adding more intersegment routes 760 to the dispatch route and assign the dispatch route to picker 740.

Once assigned, picker 740 may receive the dispatch route on their mobile device (e.g., devices 119A-119C), which may display the dispatch route and/or the next location picker 740 should move to. In some unexpected situations where picker 740 reaches capacity midway through an assigned dispatch route, mobile device may instruct picker 740 to drop off the picked products at a drop-off location (e.g., transport mechanism 214) and return to resume traversing the dispatch route. In some situations where picker 740 does not come back to the dispatch route (e.g., because the picker 740's shift is over or picker 740 has left to take a break) after a predetermined period of time, dispatch route generator 330 may release demand points remaining in the assigned dispatch route and return corresponding products to the list of products to be picked, so that they may be assigned to another picker 740.

In some embodiments, dispatch route generator 330 may stagger assigning dispatch routes by location so that only one picker is picking within a particular aisle at any given time or are far enough apart to minimize interference.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for segment based approach to routing picking, the system comprising:
a memory storing instructions; and
at least one processor configured to execute the instructions to perform operations comprising:
receiving a floorplan of a first set of location IDs, wherein the first set of location IDs correspond to locations of multiple inventory items arranged in a floor;
generating one or more base segments that connect the first set of location IDs of the multiple inventory items;
generating one or more route segments by combining the one or more base segments with one or more demand points corresponding to a second set of location IDs, wherein the second set of location IDs correspond to inventory items included in customer orders;
generating one or more dispatch routes through the one or more route segments based on an optimal routing of resources that maximizes a density metric of the multiple inventory items included in the one or more dispatch routes; and
assigning a first user to a combination of the one or more dispatch routes.

2. The computer-implemented system of claim 1, wherein the operations further comprise:
splitting the one or more route segments into subparts based on distance between a subset of the multiple inventory items connected by the one or more route segments.

3. The computer-implemented system of claim 1, wherein the operations further comprise:
detecting an erroneous route segments based on the density metric calculated for the one or more route segments; and
updating the floorplan to remove the erroneous route segments.

4. The computer-implemented system of claim 1, wherein the operations further comprise:
updating the floorplan to reflect a physical reconfiguration of the floor; and
regenerating the one or more route segments based on the updated floorplan,
wherein the physical reconfiguration comprises at least one of:
an addition or a removal of a first inventory item; or
an installation or removal of a barrier in the floor.

5. The computer-implemented system of claim 1, wherein generating the one or more dispatch routes comprises:
receiving one or more ordered items among the multiple inventory items;
mapping a second set of location IDs associated with the one or more ordered items to the one or more route segments;
generating the one or more dispatch routes by streamlining the one or more route segments to connect the second set of location IDs.

6. The computer-implemented system of claim 5, wherein the one or more ordered items are time-gated to comprise items associated with urgent orders.

7. The computer-implemented system of claim 1, wherein the optimal routing of resources comprises at least one of:
minimizing changes in a direction of the resources;
minimizing a linear length of travel by the resources;
minimizing an interference between the resources; or
maximizing the density metric of the one or more dispatch routes.

8. The computer-implemented system of claim 1, wherein each of the first set of locations IDs is individually addressable identifiers associated with a physical location in the floor.

9. The computer-implemented system of claim 1, assigning the first user to the combination of the one or more dispatch routes comprises:
determining a location of the first user based on a location of a first user device; and
assigning the first user to a first combination of the one or more dispatch routes,
wherein the first user is located closest to a starting location of the first combination of the one or more dispatch routes.

10. The computer-implemented system of claim 1, wherein maximizing the density metric of the multiple inventory items included in the one or more dispatch routes comprises maximizing one or more of: a first density of the multiple inventory items in the one or more route segments or a second density between the one or more route segments.

11. A computer-implemented method for segment based approach to routing picking, comprising:
receiving a floorplan of a first set of location IDs, wherein the first set of location IDs correspond to locations of multiple inventory items arranged in a floor;
generating one or more base segments that connect the first set of location IDs of the multiple inventory items;
generating one or more route segments by combining the one or more base segments with one or more demand points corresponding to a second set of location IDs, wherein the second set of location IDs correspond to inventory items included in customer orders;
generating one or more dispatch routes through the one or more route segments based on an optimal routing of resources that maximizes a density metric of the multiple inventory items included in the one or more dispatch routes; and
assigning a first user to a combination of the one or more dispatch routes.

12. The computer-implemented method of claim 11, further comprising:
splitting the one or more route segments into subparts based on distance between a subset of the multiple inventory items connected by the one or more route segments.

13. The computer-implemented method of claim 11, further comprising:
detecting an erroneous route segments based on the density metric calculated for the one or more route segments; and
updating the floorplan to remove the erroneous route segments.

14. The computer-implemented method of claim 11, further comprising:
updating the floorplan to reflect a physical reconfiguration of the floor; and
regenerating the one or more route segments based on the updated floorplan,
wherein the physical reconfiguration comprises at least one of:
an addition or a removal of a first inventory item; or
an installation or removal of a barrier in the floor.

15. The computer-implemented method of claim 11, wherein generating the one or more dispatch routes comprises:
receiving one or more ordered items among the multiple inventory items;
mapping a second set of location IDs associated with the one or more ordered items to the one or more route segments;
generating the one or more dispatch routes by streamlining the one or more route segments to connect the second set of location IDs.

16. The computer-implemented method of claim 15, wherein the one or more ordered items are time-gated to comprise items associated with urgent orders.

17. The computer-implemented method of claim 11, wherein the optimal routing of resources comprises at least one of:
minimizing changes in a direction of the resources;
minimizing a linear length of travel by the resources;
minimizing an interference between the resources; or
maximizing the density metric of the one or more dispatch routes.

18. The computer-implemented method of claim 11, assigning the first user to the combination of the one or more dispatch routes comprises:
determining a location of the first user based on a location of a first user device; and
assigning the first user to a first combination of the one or more dispatch routes,
wherein the first user is located closest to a starting location of the first combination of the one or more dispatch routes.

19. The computer-implemented method of claim 11, wherein maximizing the density metric of the multiple inventory items included in the one or more dispatch routes comprises maximizing one or more of: a first density of the multiple inventory items in the one or more route segments or a second density between the one or more route segments.

20. A computer-implemented system for segment based approach to routing picking, the system comprising:
a memory storing instructions; and
at least one processor configured to execute the instructions to perform operations comprising:
receiving a floorplan of a first set of location IDs, wherein the first set of location IDs correspond to locations of multiple inventory items arranged in a floor;
generating one or more base segments that connect the first set of location IDs of the multiple inventory items;
receiving one or more urgent items among the multiple inventory items;
generating one or more route segments by combining the one or more base segments with one or more demand points corresponding to a second set of location IDs of the one or more urgent items;
generating one or more dispatch routes through the one or more route segments, wherein the one or more dispatch routes maximize a density metric, calculated between first adjacent pairs of the second set of location IDs or between second adjacent pairs of one or more route segments;
determining a first location of a first user device configured to communicate the first location of a user in possession of the first user device; and
generating a signal to the first user device to traverse the one or more dispatch routes, wherein the first user device is located closest to a starting point of the one or more dispatch routes as determined by the first location.
